(19) United States
(12) Patent Application Publication
(10) Pub. No.: US 2016/0122464 A1
(43) Pub. Date: May 5, 2016

(54) SOLVENT FREE POLYISOBUTYLENE BASED POLYURETHANES

(71) Applicant: Cardiac Pacemakers, Inc., St. Paul, MN (US)

(72) Inventors: Jan Seppala, Loretto, MN (US); Kasyap Seethamraju, Eden Prairie, MN (US); Ronald A. Dombro, St. Paul, MN (US); James Lasch, Oakdale, MN (US); Paul V. Grosso, Maple Grove, MN (US)

(21) Appl. No.: 14/972,317

(22) Filed: Dec. 17, 2015

Related U.S. Application Data
(62) Division of application No. 14/528,449, filed on Oct. 30, 2014.

(51) Int. Cl. C08G 18/73; C08G 18/32

(52) U.S. Cl. CPC C08G 18/73; C08G 18/3206

(57) ABSTRACT

A biocompatible polyisobutylene urethane, urea, and urethane/urea copolymer including hard segments, soft segments and that is free of urethane, urea or urethane/urea solvents. The hard include diisocyanate residue. The soft segments include at least one polyisobutylene diol or diamine and optionally a polyether diol.

### CROSS-REFERENCE TO RELATED APPLICATION

This application is a division of U.S. application Ser. No. 14/528,449, filed Oct. 30, 2014, which is hereby incorporated by reference in its entirety.

### TECHNICAL FIELD

The present disclosure relates to urethane, urea and urethane/urea copolymers, and methods of making and medical devices containing the same.

### BACKGROUND

Polymeric materials can be used in medical devices for implantation or insertion into the body of a patient. For example, polymeric materials such as silicone rubber, polyurethane, and fluoropolymers, for instance, polytetrafluoroethylene (PTFE), expanded PTFE (ePTFE) and ethylene tetrafluoroethylene (ETFE), are used as coating materials/insulation for medical leads, providing mechanical protection, electrical insulation, or both.

### SUMMARY

In Example 1, a biocompatible polyisobutylene urethane, urea or urethane/urea copolymer including hard segments and soft segments. The hard segments including diisocyanate residue and present in an amount of about 30% to about 60% by weight of the biocompatible polyisobutylene urethane, urea or urethane/urea copolymer. The soft segments including at least one polyisobutylene diol or diamine and optionally a polyether diol and present in an amount of about 40% to about 70% by weight of the biocompatible polyisobutylene urethane, urea or urethane/urea copolymer. The biocompatible polyisobutylene urethane, urea or urethane/urea copolymer is free of urethane, urea or urethane/urea solvents

In Example 2, the biocompatible polyisobutylene urethane, urea or urethane/urea copolymer according to Example 1, wherein the at least one polyisobutylene diol or diamine is present in an amount of about 70% to about 90% by weight of the soft segments and the polyether diol is present in an amount of about 5% to about 40% by weight of the soft segments.

In Example 3, the biocompatible polyisobutylene urethane, urea or urethane/urea copolymer according to Example 1-2, wherein the soft segments include polytetramethylene oxide diol.

In Example 4, the biocompatible polyisobutylene urethane, urea or urethane/urea copolymer according to any one of Examples 1-2, wherein the at least one polyisobutylene diol or diamine is present in an amount of about 70% to about 100% by weight of the soft segments and the soft segments are free of a polyether diol.

In Example 5, the biocompatible polyisobutylene urethane, urea or urethane/urea copolymer according to any one of Examples 1-2 and 4, wherein the soft segments are free of polytetramethylene oxide diol.

In Example 6, the biocompatible polyisobutylene urethane, urea or urethane/urea copolymer according to any one of Examples 1-7, wherein six months after synthesis of the biocompatible polyisobutylene urethane, urea or urethane/urea copolymer the biocompatible polyisobutylene urethane, urea or urethane/urea copolymer is free of urethane, urea or urethane/urea solvents.

In Example 7, the biocompatible polyisobutylene urethane, urea or urethane/urea copolymer according to any one of Examples 1-6, wherein one hour after synthesis of the biocompatible polyisobutylene urethane, urea or urethane/urea copolymer the biocompatible polyisobutylene urethane, urea or urethane/urea copolymer is free of urethane, urea or urethane/urea solvents.

In Example 8, the biocompatible polyisobutylene urethane, urea or urethane/urea copolymer according to any one of Examples 1-7, wherein a diisocyanate:polyisobutylene diol or diamine molar ratio of the biocompatible polyisobutylene urethane, urea or urethane/urea copolymer is between about 0.92 and about 1.10.

In Example 9, the biocompatible polyisobutylene urethane, urea or urethane/urea copolymer according to any one of Examples 1-8 formed by reactive extrusion.

In Example 10, the biocompatible polyisobutylene urethane, urea or urethane/urea copolymer according to any one of Examples 1-10, wherein the biocompatible polyisobutylene urethane, urea or urethane/urea copolymer is free of tetrahydrofuran (THF), dimethylformamide (DMF) and toluene.

In Example 11, the biocompatible polyisobutylene urethane, urea or urethane/urea copolymer according to any one of Examples 1-10, wherein the biocompatible polyisobutylene urethane, urea or urethane/urea copolymer is free of a catalyst.

In Example 12, a method of manufacturing a polyisobutylene urethane, urea or urethane/urea copolymer includes reacting hard segment components and soft segment components in a compounding extruder in the absence of urethane, urea or urethane/urea solvents to produce the polyisobutylene urethane, urea or urethane/urea copolymer and extruding the polyisobutylene urethane, urea or urethane/urea copolymer. The soft segment components are present in an amount of about 40% to about 70% by weight of the biocompatible polyisobutylene urethane, urea or urethane/urea copolymer and include at least one polyisobutylene diol or diamine and optionally a polyether. The hard segment components are present in an amount of about 30% to about 60% by weight of the biocompatible polyisobutylene urethane and include diisocyanate residue.

In Example 13, the method according to Example 12, wherein the soft segment components are free of a polyether diol.

In Example 14, the method according to any one of Examples 12-13 wherein a diisocyanate:polyisobutylene diol or diamine molar ratio is between about 0.92 and about 1.10.

In Example 15, the method according to any one of Examples 12-14, wherein the step of reacting hard segment components and soft segment components in the compounding extruder to produce the copolymer is substantially free of a catalyst.

In Example 16, the method according to any one of Examples 12-14, wherein the step of reacting hard segment components and soft segment components includes adding about 30 ppm catalyst or less by weight of the hard segment components and the soft segment components to the compounding extruder.

In Example 17, the method according to any one of Examples 12-16, and further including combining the hard segment components and the soft segment components to form end-capped prepolymers prior to the step of reacting the hard segment components and soft segment components to produce the copolymer.

In Example 18, the method according to any one of Examples 12-17, wherein reacting the hard segment components and soft segment components includes adding a chain extender to the compounding extruder.

In Example 19, the method according to any one of Examples 12-18, wherein the hard segment components and soft segment components are reacted in the compounding extruder at a temperature of about 200 degrees Celsius or less.

In Example 20, the method according to any one of Examples 12-19, wherein extruding the polyisobutylene urethane, urea or urethane/urea copolymer includes extruding the polyisobutylene urethane, urea or urethane/urea copolymer to form a implantable medical device component.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates an exemplary reactive extrusion system.

FIGS. 2A-2C illustrate additional exemplary reactive extrusion systems.

FIG. 3 illustrates a still further exemplary reactive system which includes direct extrusion.

While the invention is amenable to various modifications and alternative forms, specific embodiments have been shown by way of example in the drawings and are described in detail herein. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

A more complete understanding of the present invention is available by reference to the following detailed description of numerous aspects and embodiments of the invention. The detailed description of the invention which follows is intended to illustrate but not limit the invention.

In accordance with various aspects of the disclosure, polyisobutylene urethane, urea and urethane/urea copolymers (also referred to herein collectively as “polyisobutylene urethane copolymer”) and methods for making the same are disclosed. Polyisobutylene urethane copolymers are thermoplastic polyurethanes (TPUs) that contain hard and soft segments. Polyisobutylene urethane copolymers are particularly useful in medical devices used for insertion or implantation into a patient because they are hydrolytically stable and have good oxidative stability. Medical devices that can be implantable or insertable into the body of a patient and that comprise at least one polyisobutylene urethane copolymer are also disclosed.

As is well known, “polymers” are molecules containing multiple copies (e.g., from 5 to 10 to 25 to 50 to 100 to 250 to 500 to 1000 or more copies) of one or more constitutional units, commonly referred to as monomers. As used herein, the term “monomers” may refer to free monomers and to those that have been incorporated into polymers, with the distinction being clear from the context in which the term is used.

Polymers may take on a number of configurations including linear, cyclic and branched configurations, among others. Branched configurations include star-shaped configurations (e.g., configurations in which three or more chains emanate from a single branch point), comb configurations (e.g., configurations having a main chain and a plurality of side chains, also referred to as “graft” configurations), dendritic configurations (e.g., arborescent and hyperbranched polymers), and so forth.

As used herein, “homopolymers” are polymers that contain multiple copies of a single constitutional unit (i.e., a monomer). “Copolymers” are polymers that contain multiple copies of at least two dissimilar constitutional units.

Polyurethanes are a family of copolymers that are synthesized from polyfunctional isocyanates (e.g., diisocyanates, including both aliphatic and aromatic diisocyanates) and polyols (e.g., macroglycols). Commonly employed macroglycols include polyester diols, polyether diols and polycarbonate diols. The macroglycols can form polymeric segments of the polyurethane. Aliphatic or aromatic diols or diamines may also be employed as chain extenders, for example, to impart improved physical properties to the polyurethane. Where diamines are employed as chain extenders, urea linkages are formed and the resulting polymers may be referred to as polyurethane/polyureas.

Polyureas are a family of copolymers that are synthesized from polyfunctional isocyanates and polyamines, for example, diamines such as polyester diamines, polyether diamines, polysiloxane diamines, polyhydrocarbon diamines and polycarbonate diamines. As with polyurethanes, aliphatic or aromatic diols or diamines may be employed as chain extenders.

In some embodiments, the polyisobutylene urethane copolymer includes (a) one or more polyisobutylene segments, (b) one or more additional polymeric segments (other than polyisobutylene segments), (c) one or more segments that includes one or more diisocyanate residues, and optionally (d) one or more chain extenders.

As used herein, a “polymeric segment” or “segment” is a portion of a polymer. Segments can be unbranched or branched. Segments can contain a single type of constitutional unit (also referred to herein as “homopolymeric segments”) or multiple types of constitutional units (also referred to herein as “copolymeric segments”) which may be present, for example, in a random, statistical, gradient, or periodic (e.g., alternating) distribution.

The polyisobutylene segments of the polyisobutylene urethane copolymers are generally considered to constitute soft segments, while the segments containing the diisocyanate residues are generally considered to constitute hard segments. The additional polymeric segments may include soft or hard polymeric segments. As used herein, soft and hard segments are relative terms to describe the properties of polymer materials containing such segments. Without limiting the foregoing, a soft segment may display a glass transition temperature (Tg) that is below body temperature, more typically from 35° C. to 20° C. to 0° C. to −25° C. to −50° C. or below. A hard segment may display a Tg that is above body temperature, more typically from 40° C. to 50° C. to 75° C. to 100° C. or above. Tg can be measured by differential scanning calorimetry (DSC), dynamic mechanical analysis (DMA) and/or thermomechanical analysis (TMA).

Suitable additional soft segments include linear, branched or cyclic polyalkyl, polyalkene and polyalkenyl segments, polyether segments, fluoropolymer segments including fluorinated polyether segments, polyester segments, poly(acrylate) segments, poly(methacrylate) segments, polysiloxane segments and polycarbonate segments.

Examples of suitable polyether segments include linear, branched and cyclic homopoly(alkylene oxide) and copoly(alkylene oxide) segments, including homopolymeric and copolymeric segments formed from one or more, among others, methylene oxide, dimethylene oxide (ethylene oxide), trimethylene oxide, propylene oxide, tetramethylene oxide, pentamethylene oxide, hexamethylene oxide, octamethylene oxide and decamethylene oxide.

Examples of suitable fluoropolymer segments include perfluoroacrylate segments and fluorinated polyether segments, for example, linear, branched and cyclic homopoly(fluorinated alkylene oxide) and copoly(fluorinated alkylene oxide) segments, including homopolymeric and copolymeric segments formed from one or more of, among others, perfluoromethylene oxide, perfluorodimethylene oxide (perfluoroethylene oxide), perfluorotrimethylene oxide and perfluoropropylene oxide.

Examples of suitable polyester segments include linear, branched and cyclic homopolymeric and copolymeric segments formed from one or more of, among others, alkyleneadipates including ethyleneadipate, propyleneadipate, tetramethyleneadipate, and hexamethyleneadipate.

Examples of suitable poly(acrylate) segments include linear, branched and cyclic homopoly(acrylate) and copoly(acrylate) segments, including homopolymeric and copolymeric segments formed from one or more of, among others, alkyl acrylates such as methyl acrylate, ethyl acrylate, propyl acrylate, isopropyl acrylate, butyl acrylate, sec-butyl acrylate, isobutyl acrylate, 2-ethylhexyl acrylate and dodecyl acrylate.

Examples of suitable poly(methacrylate) segments include linear, branched and cyclic homopoly(methacrylate) and copoly(methacrylate) segments, including homopolymeric and copolymeric segments formed from one or more of, among others, alkyl methacryates such as hexyl methacrylate, 2-ethylhexyl methacrylate, octyl methacrylate, dodecyl methacrylate and octadecyl methacrylate.

Examples of suitable polysiloxane segments include linear, branched and cyclic homopolysiloxane and copolysiloxane segments, including homopolymeric and copolymeric segments formed from one or more of, among others, dimethyl siloxane, diethyl siloxane, and methylethyl siloxane.

Examples of suitable polycarbonate segments include those comprising one or more types of carbonate units,

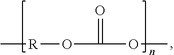

where R may be selected from linear, branched and cyclic alkyl groups. Specific examples include homopolymeric and copolymeric segments formed from one or more of, among others, ethylene carbonate, propylene carbonate, and hexamethylene carbonate.

Examples of suitable additional hard polymeric segments include various poly(vinyl aromatic) segments, poly(alkyl acrylate) and poly(alkyl methacrylate) segments.

Examples of suitable poly(vinyl aromatic) segments include linear, branched and cyclic homopoly(vinyl aromatic) and copoly(vinyl aromatic) segments, including homopolymeric and copolymeric segments formed from one or more vinyl aromatic monomers including, among others, styrene, 2-vinyl naphthalene, alpha-methyl styrene, p-methoxystyrene, p-acetoxystyrene, 2-methylstyrene, 3-methylstyrene and 4-methylstyrene.

Examples of suitable poly(alkyl acrylate) segments include linear, branched and cyclic homopoly(alkyl acrylate) and copoly(alkyl acrylate) segments, including homopolymeric and copolymeric segments formed from one or more acrylate monomers including, among others, tert-butyl acrylate, hexyl acrylate and isobornyl acrylate.

Examples of suitable poly(alkyl methacrylate) segments include linear, branched and cyclic homopoly(alkyl methacrylate) and copoly(alkyl methacrylate) segments, including homopolymeric and copolymeric segments formed from one or more alkyl methacrylate monomers including, among others, methyl methacrylate, ethyl methacrylate, isopropyl methacrylate, isobutyl methacrylate, t-butyl methacrylate, and cyclohexyl methacrylate.

In some embodiments, a suitable polyisobutylene urethane copolymer can include (a) a polyisobutylene soft segment, (b) optionally a polyether soft segment, (c) a hard segment containing diisocyanate residues, (d) optionally a chain extender, and (e) optionally an end capping material.

The weight ratio of soft segments to hard segments in the polyisobutylene urethane copolymers of the various embodiments can be varied to achieve a wide range of physical and mechanical properties, including Shore Hardness, and to achieve an array of desirable functional performance. For example, the weight ratio of soft segments to hard segments in the polymer can be varied from 99:1 to 95:5 to 90:10 to 75:25 to 50:50 to 25:75 to 10:90 to 5:95 to 1:99, more particularly from 95:5 to 90:10 to 80:20 to 70:30 to 65:35 to 60:40 to 50:50, and even more particularly, from about 80:20 to about 50:50. In some embodiments, the soft segment components can be about 40% to about 70% by weight of the copolymer, and the hard segment components can be about 30% to about 60% by weight of the copolymer.

In some embodiments, the copolymer may include polyisobutylene in an amount of about 70% to about 100% by weight of the soft segments and polyether in an amount of about 5% to about 40% by weight of the soft segments. For example, the copolymer may include soft segments in an amount of about 40% to about 70% by weight of the copolymer, of which polyisobutylene is present in an amount of about 70% to about 100% by weight of the soft segments and polyether is present in an amount of about 0% to about 40% by weight of the soft segments. In another example, the copolymer may include soft segments in an amount of about 40% to about 70% by weight of the copolymer, of which polyisobutylene (e.g., a polyisobutylene diol or diamine) is present in an amount of about 70% to about 95% by weight of the soft segments and polyether (e.g., polytetramethylene oxide diol) is present in an amount of about 5% to about 40% by weight of the soft segments.

An isocyanate index (iso index) is the molar ratio of diisocyanate to polyisobutylene. The polyisobutylene urethane copolymer may have an isoindex between about 0.92 and about 1.10, and more preferably between about 0.98 and about 1.02.

The Shore Hardness of the polyisobutylene urethane copolymers of the various embodiments can be varied by controlling the weight ratio of soft segments to hard segments. Shore Hardness may be measured according to ASTM D2240-00. Suitable Shore Hardness ranges include from 45A to 70D. Additional suitable Shore Hardness ranges include for example, from 45A, and more particularly from 50A to 52.5A to 55A to 57.5A to 60A to 62.5A to 65A to 67.5A to 70A to 72.5A to 75A to 77.5A to 80A to 82.5A to 85A to 87.5A to 90A to 92.5A to 95A to 97.5A to 100A. In one embodiment, a polyisobutylene urethane copolymer with a soft segment to hard segment weight ratio of 80:20 results in a Shore Hardness of about 60 to 71A, a polyisobutylene urethane copolymer having a soft segment to hard segment weight ratio of 65:35 results in a Shore Hardness of 80 to 83A, a polyisobutylene urethane copolymer having a soft segment to hard segment weight ratio of 60:40 result in a Shore Hardness 95 to 99A, and a polyisobutylene urethane copolymer having a soft segment to hard segment weight ratio of 50:50 result in a Shore Hardness >100A. Higher hardness materials (e.g., 55D to 75D) can also be prepared by increasing the ratio of hard to soft segments. Such harder materials may be particularly suitable for use in certain implantable medical devices, such as in tip and pin areas of leads and headers of neuromodulation cans, for example.

The polyisobutylene and additional polymeric segments can vary widely in molecular weight, but can be composed of between 2 and 100 repeat units (monomer units), among other values, and can be incorporated into the polyisobutylene urethane copolymers of the various embodiments in the form of polyol (e.g., diols, triols, etc.) or polyamine (e.g., diamines, triamines, etc.) starting materials. Although the discussion to follow is generally based on the use of polyols, analogous methods may be performed and analogous compositions may be created using polyamines and polyol/polyamine combinations.

Suitable polyisobutylene polyol starting materials include linear polyisobutylene diols and branched (three-arm) polyisobutylene triols. More specific examples include linear polyisobutylene diols with a terminal —OH functional group at each end. Further examples of polyisobutylene polyols include poly(styrene-co-isobutylene)diols and poly(styrene-b-isobutylene-b-styrene)diols which may be formed, for example, using methods analogous to those described in J. P. Kennedy et al., “Designed Polymers by Carbocationic Macromolecular Engineering: Theory and Practice,” Hanser Publishers 1991, pp. 191-193, Joseph P. Kennedy, Journal of Elastomers and Plastics 1985 17: 82-88, and the references cited therein. The polyisobutylene diol starting materials can be formed from a variety of initiators as known in the art. In one embodiment, the polyisobutylene diol starting material is a saturated polyisobutylene diol that is devoid of C═C bonds.

Examples of suitable polyether polyol starting materials include polytetramethylene oxide diols and polyhexamethylene diols, which are available from various sources including Sigma-Aldrich Co., Saint Louis, Mo., USA and E. I. DuPont de Nemours and Co., Wilmington, Del., USA. Examples of polysiloxane polyol starting materials include polydimethylsiloxane diols, available from various sources including Dow Corning Corp., Midland Mich., USA, and Chisso Corp., Tokyo, Japan. Examples of suitable polycarbonate polyol starting materials include polyhexamethylene carbonate diols such as those available from Sigma-Aldrich Co. Examples of polyfluoroalkylene oxide diol starting materials include ZDOLTX, Ausimont, Bussi, Italy, a copolyperfluoroalkylene oxide diol containing a random distribution of —CF₂CF₂O— and —CF₂O— units, end-capped by ethoxylated units, i.e., H(OCH₂CH₂)ₙOCH₂CF₂O(CF₂CF₂O)ₚ(CF₂O)_{q}CF₂CH₂O(CH₂CH₂O)ₙH, where n, p and q are integers. Suitable polystyrene diol starting materials (α,ω-dihydroxy-terminated polystyrene) of varying molecular weight are available from Polymer Source, Inc., Montreal, Canada. Polystyrene diols and three-arm triols may be formed, for example, using procedures analogous to those described in M. Weiβmüller et al., “Preparation and end-linking of hydroxyl-terminated polystyrene star macromolecules,” Macromolecular Chemistry and Physics 200(3), 1999, 541-551.

In some embodiments, polyols (e.g., diols, triols, etc.) are synthesized as block copolymer polyols. Examples of such block copolymer polyols include poly(tetramethylene oxide-b-isobutylene)diol, poly(tetramethylene oxide-b-isobutylene-b-tetramethylene oxide)diol, poly(dimethyl siloxane-b-isobutylene)diol, poly(dimethyl siloxane-b-isobutylene-b-dimethyl siloxane)diol, poly(hexamethylene carbonate-b-isobutylene)diol, poly(hexamethylene carbonate-b-isobutylene-b-hexamethylene carbonate)diol, poly(methyl methacrylate-b-isobutylene)diol, poly(methyl methacrylate-b-isobutylene-b-methyl methacrylate)diol, poly(styrene-b-isobutylene)diol and poly(styrene-b-isobutylene-b-styrene)diol (SIBS diol).

Diisocyanates for use in forming the polyisobutylene urethane copolymers of the various embodiments include aromatic and non-aromatic (e.g., aliphatic) diisocyanates. Aromatic diisocyanates may be selected from suitable members of the following, among others: 4,4′-methylenediphenyl diisocyanate (MDI), 2,4- and/or 2,6-toluene diisocyanate (TDI), 1,5-naphthalene diisocyanate (NDI), para-phenylene diisocyanate, 3,3′-tolidene-4,4′-diisocyanate and 3,3′-dimethyl-diphenylmethane-4,4′-diisocyanate. Non-aromatic diisocyanates may be selected from suitable members of the following, among others: 1,6-hexamethylene diisocyanate (HDI), 4,4′-dicyclohexylmethane diisocyanate, 3-isocyanatomethyl-3,5,5-trimethylcyclohexyl isocyanate (isophorone diisocyanate or IPDI), cyclohexyl diisocyanate, and 2,2,4-trimethyl-1,6-hexamethylene diisocyanate (TMDI).

In some embodiments, a polyether diol such as polytetramethylene oxide diol (PTMO diol), polyhexametheylene oxide diol (PHMO diol), polyoctamethylene oxide diol or polydecamethylene oxide diol, can be combined with a polyisobutylene diol and diisocyanate to form a polyisobutylene polyurethane copolymer. In some embodiments, the polyisobutylene urethane copolymer may have a generally uniform distribution of polyurethane hard segments, polyisobutylene segments and polyether segments to achieve favorable micro-phase separation in the polymer. In some embodiments, polyether segments may improve key mechanical properties such as Shore Hardness, tensile strength, tensile modulus, flexural modulus, elongation, tear strength, flex fatigue, tensile creep, and/or abrasion performance, among others.

The polyisobutylene urethane copolymers in accordance with the various embodiments may further include one or more optional chain extender residues and/or end groups. Chain extenders can increase the hard segment length, which can in turn results in a copolymer with a higher tensile modulus, lower elongation at break and/or increased strength. Stated another way, chain extenders can increase the ratio of hard segment material to soft segment material of the polyisobutylene urethane copolymer. In some embodiments, the molar ratio of soft segment to chain extender to diisocyanate (SS:CE:DI) can range, for example, from 1:9:10 to 2:8:10 to 3:7:10 to 4:6:10 to 5:5:10 to 6:4:10 to 7:3:10 to 8:2:10 to 9:1:10.

Chain extenders can be formed from aliphatic or aromatic diols (in which case a urethane bond is formed upon reaction with an isocyanate group) or aliphatic or aromatic diamines (in which case a urea bond is formed upon reaction with an isocyanate group). Chain extenders may be selected from suitable members of the following, among others: alpha,omega-alkane diols such as ethylene glycol (1,2-ethane diol), 1,4-butanediol (BDO), 1,6-hexanediol, alpha,omega-alkane diamines such as ethylene diamine, dibutylamine (1,4-butane diamine) and 1,6-hexanediamine, or 4,4′-methylene bis(2-chloroaniline). Chain extenders may be also selected from suitable members of, among others, short chain diol polymers (e.g., alpha,omega-dihydroxy-terminated polymers having a molecular weight less than or equal to 1000) based on hard and soft polymeric segments (more typically soft polymeric segments) such as those described above, including short chain polyisobutylene diols, short chain polyether polyols such as polytetramethylene oxide diols, short chain polysiloxane diols such as polydimethylsiloxane diols, short chain polycarbonate diols such as polyhexamethylene carbonate diols, short chain poly(fluorinated ether)diols, short chain polyester diols, short chain polyacrylate diols, short chain polymethacrylate diols, and short chain poly(vinyl aromatic)diols.

In some embodiments, the biostability and/or biocompatibility of the polyisobutylene urethane copolymers in accordance with the various embodiments may be improved by end-capping the copolymers with short aliphatic chains (e.g., [—CH₂]ₙ—CH₃ groups, [—CH₂]ₙ—C(CH₃)₃ groups, [—CH₂]ₙ—CF₃ groups, [—CH₂]ₙ—C(CF₃)₃ groups, [—CH₂]ₙ—CH₂OH groups, [—CH₂]ₙ—C(OH)₃ groups and [—CH₂]ₙ—C₆H₅ groups, etc., where n may range, for example, from 1 to 2 to 5 to 10 to 15 to 20, among others values) that can migrate to the polymer surface and self-assemble irrespective of synthetic process to elicit desirable immunogenic response when implanted in vivo. Alternatively, a block copolymer or block terpolymer with short aliphatic chains (e.g., [—CH₂]ₙ-b-[—CH₂O]ₙ—CH₃ groups, [—CH₂]ₙ-b-[—CH₂O]ₙ—CH₂CH₂C(CH₃)₃ groups, [—CH₂]ₙ-b-[—CH₂O]ₙ—CH₂CH₂CF₃ groups, [—CH₂]ₙ-b-[—CH₂O]ₙ—CH₂CH₂C(CF₃)₃ groups, [—CH₂]ₙ-b-[—CH₂O]ₙ—CH₂CH₂OH groups, [—CH₂]ₙ-b-[—CH₂O]ₙ—C(OH)₃ groups, [—CH₂]ₙ-b-[—CH₂O]ₙ—CH₂CH₂—C₆H₅ groups, etc., where n may range, for example, from 1 to 2 to 5 to 10 to 15 to 20, among others values) that can migrate to the surface and self-assemble can be blended with the copolymer toward the end of synthesis. These end-capping segments may also help to improve the thermal processing of the polymer by acting as processing aids or lubricants. Processing aids, antioxidants, waxes and the like may also be separately added to aid in thermal processing.

In some embodiments, a polyisobutylene urethane copolymer can be synthesized by reactive extrusion. In reactive extrusion, the hard segment and soft segment components are mixed and reacted in extrusion equipment to form a polyisobutylene urethane copolymer. In one example, 4,4′-methylenediphenyl diisocyanate (MDI), polytetramethylene oxide diol (PTMO diol) and polyisobutylene diol (PIBDIOL) can be mixed in extruding equipment. A chain extender, such as BDO, may also be added. The hard segment components, soft segment components and chain extender are mixed in the extruding equipment and can react and/or polymerize to form a polyisobutylene urethane copolymer. Additional or alternative components (including additional hard segment components, soft segment components and chain extenders) can be added to the extruding equipment during mixing.

In some embodiments, the reactive extrusion can be carried out in the absence of a urethane, urea or urethane/urea solvent. That is, in some embodiments, a urethane, urea or urethane/urea solvent is not added to the extrusion equipment during synthesis of the polyisobutylene urethane copolymer. As used herein, a urethane, urea or urethane/urea solvent is a substance capable of dissolving the urethane, urea or urethane/urea used in the synthesis of the copolymer. Exemplarily urethane, urea or urethane/urea solvents include but are not limited to tetrahydrofuran (THF), dimethylformamide (DMF), toluene and combinations thereof.

Polyisobutylene urethane copolymer synthesized in the absence of a urethane, urea or urethane/urea solvent is solvent-free or does not contain solvent. That is, immediately following synthesis as well as at any time following synthesis (such as 6 months, 1 year or 2 years after synthesis) the polyisobutylene urethane copolymer is free of a urethane, urea or urethane/urea solvent. In previous solvent-based synthesis methods, the copolymer was subjected to a devolatilizing step to remove solvent from the copolymer after reaction or polymerization. The current reactive extrusion process does not require a devolatilizing step because the synthesis does not use solvent and thus, the synthesized polyisobutylene urethane copolymer is free of solvent.

The polyisobutylene urethane copolymer may be formed in any suitable extrusion equipment. For example, a compounding extruder may be used. In some embodiments, the compounding extruder may be a single-screw extruder. In other embodiments, a twin-screw extruder may be used. Additionally or alternatively, the extrusion equipment may have a single zone or multiple zones, enabling different processing conditions (e.g., temperature, mixing, addition of components) at various zones.

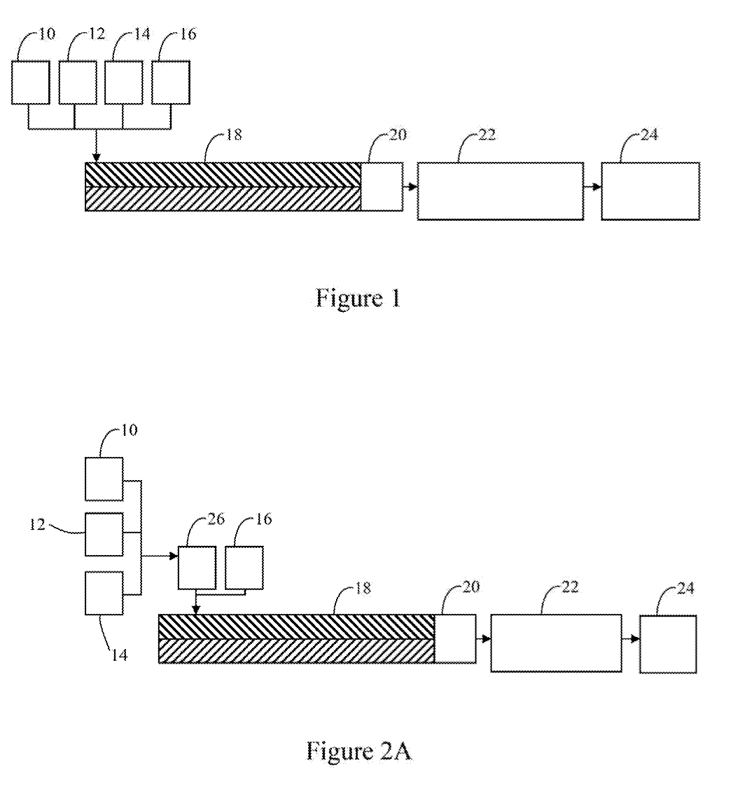

In some embodiments, as illustrated in FIG. 1, the polyisobutylene urethane copolymer can be synthesized by a one-step reactive extrusion process. For example, all components of the copolymer may be added to the extrusion system at the same location and at the same time. In FIG. 1, a PIBDIOL 10, a PTMO 12, a MDI 14 and a BDO 16 are mixed, reacted and polymerized in a compounding extruder 18. One or more pumps can be used to meter the component flow to the compounding extruder 18.

The components of the polyisobutylene urethane copolymer can be mixed by the compounding extruder 18 as they travel along the length of the compounding extruder 18. The compounding extruder 18 can be a single zone extruder or a multiple zone extruder. The compounding extruder 18 can comprise a series of conveying and/or kneading elements, and the compounding extruder 18 can mix the PIBDIOL 10, the PTMO 12, the MDI 14 and the BDO 16 as the components travel the length of the compounding extruder 18. For example, the compounding extruder 18 may be a segmented barrel counter-rotating twin screw extruder or a segmented barrel co-rotating twin screw extruder.

The hard and soft segment components that form the polyisobutylene urethane copolymer may be immiscible. The conveying and kneading elements of compounding extruder 18 can impart high shear stresses on the components to increase dispersion of the immiscible hard and soft segment components without the need for solvent as discussed herein. Mixing of the hard and soft segments components by the compounding extruder 18 may also increase the homogeneity of the polyisobutylene urethane copolymer.

The PIBDIOL 10, the PTMO 12, the MDI 14 and the BDO 16 can be pre-heated before addition to the compounding extruder 18. For example, the PIBDIOL 10, the PTMO 12, the MDI 14 and the BDO 16 can be heated to between about 60° C. and about 200° C. Pre-heating the components may reduce the viscosity of the components and increase dispersion of the components during mixing by the compounding extruder 18.

The hard and soft components react and/or polymerize to form the polyisobutylene urethane copolymer as they travel through the compounding extruder 18. In some embodiments, the compounding extruder 18 can be heated to promote polymerization. For example, the compounding extruder 18 may include barrels which may be heated. In some examples, the temperature of the compounding extruder 18 does not exceed about 250° C. In other examples, the compounding extruder 18 is maintained at a temperature between about 140° C. and about 225° C. Maintaining a low temperature in the compounding extruder 18 can prevent undesired side reactions or crystallization of the polyisobutylene urethane copolymer which affects the material properties of the copolymer.

The speed of the material (e.g., the PIBDIOL 10, the PTMO 12, the MDI 14, the BDO 16, and/or the polyisobutylene urethane copolymer) through the compounding extruder 18 is known as residence time. The residence time of the polyisobutylene urethane copolymer through the compounding extruder 18 can be varied to control polymerization. For example, increasing the residence time within the compounding extruder 18 increases the time the components are in the compounding extruder 18 and may increase or decrease the molecular weight of the polyisobutylene urethane copolymer.

The polyisobutylene urethane copolymer exits the compounding extruder 18 as a melt. The temperature of the melt can be adjusted to prevent undesired side reactions and crystallization of the hard segments of the polyisobutylene urethane copolymer. For example, the melt may have a temperature between about 108° C. and about 200° C. as it exits the compounding extruder 18 at the end of the compounding step.

After exiting the compounding extruder 18, the melt is fed through a die 20, a chiller 22 and a cutter 24. The die 20 forms the melt into a desired shape or form. For example, the die 20 can be a sheet die or a multi strand die. After the die 20, the melt is conveyed to the chiller 22 where it is cooled. For example, the chiller 22 can be a water bath, a chilled roll or a chilled belt. The cutter 24 forms the polyisobutylene urethane copolymer into smaller pieces. For example, the cutter 24 can be a pelletizer, grinder or dicer.

A vacuum drying step can be used to finish the curing of the polyisobutylene urethane copolymer. In one example, drying temperatures of below about 100° C. are used to prevent crystallization of the hard segments of the polyisobutylene urethane copolymer. In another example, drying temperatures are between about 50° C. and about 100° C. The drying time can be controlled to adjust the final molecular weight of the polyisobutylene urethane copolymer. For example, a longer drying time may form polyisobutylene urethane copolymer having a higher or lower molecular weight.

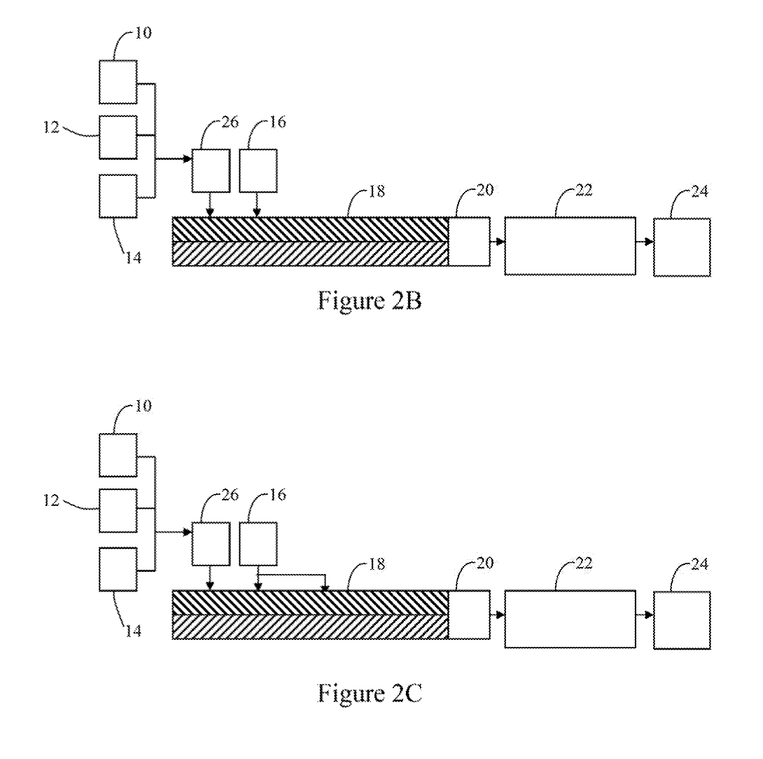

In some embodiments, the polyisobutylene urethane copolymer may be synthesized by a two-step reactive extrusion process. In the exemplary two-step reactive extrusion process of FIG. 2A, the PIBDIOL 10 and the PTMO 12 are capped with excess MDI 14 to form a prepolymer 26. The end-capped prepolymer 26 is then mixed with the BDO 16 in the compounding extruder 18. That is, the hard and soft segment components are mixed to form the prepolymer 26, and the prepolymer 26 is reacted with the BDO 16 in the compounding extruder 18 to produce the polyisobutylene urethane copolymer. As illustrated in FIG. 2A, the prepolymer 26 and the BDO 16 can be mixed prior to their addition to the compounding extruder 18.

In the exemplary process, illustrated in FIG. 2B, the BDO 16 can be added to the compounding extruder 18 downstream of the addition of the prepolymer 26. Downstream introduction of the BDO 16 permits mixing of the prepolymer 26 in the upstream zones of the compounding extruder 18 prior to introduction of the BDO 16.

The BDO 16 can be added at multiple locations along the length of the compounding extruder 18. For example, as shown in FIG. 2C, the BDO 16 may be added to the compounding extruder 18 at two separate and discrete locations downstream of the addition of the prepolymer 26. The location(s) of introduction of the BDO 16 can be varied to tailor the resulting polyisobutylene urethane copolymer. For example, the BDO 16 can be introduced at multiple locations along the length of the compounding extruder 18, which can reduce or prevent the synthesis of longer MDI-BDO-MDI segments. Adding the BDO 16 at multiple locations may be particularly beneficial in processes experiencing phase separation and may result in the production of more homogenous polyisobutylene urethane copolymer.

As described above, the compounding extruder 18 can be heated. The temperature of the compounding extruder 18 and the residence time can be varied to permit synthesis of the polyisobutylene urethane copolymer without the use of a catalyst. In other examples, a catalyst may be used. For example, a catalyst in an amount less than or equal to about 30 ppm can be added to the compounding extruder 18.

When a catalyst is used, the catalyst can be mixed with the BDO 16 prior to addition to the compounding extruder 18. Alternatively, the catalyst can be added to the compounding extruder 18 in a stream separate from the other components. In one example, the catalyst is added to the compounding extruder 18 as a diluent in a carrier, that is added to the compounding extruder 18 as a separate stream. The location of catalyst addition can aid in controlling the length of the MDI-BDO-MDI segments. The reactive extrusion process enables the catalyst to be introduced into the polymerization process at any point. The flexibility of the reactive extrusion process enables tailoring of the polyisobutylene urethane produced.

Additives, such as processing aids, heat stabilizers, antioxidants and lubricants, can be mixed with any of the feed streams. For example, at least one additive can be mixed with the prepolymer 26 prior to addition of the prepolymer 26 to the compounding extruder 18. Additives can also be added to the compounding extruder 18 at a location or locations separate and discrete from the other component streams. The compounding extruder 18 mixes the optional additives with the polyisobutylene urethane copolymer components to form a homogenous copolymer.

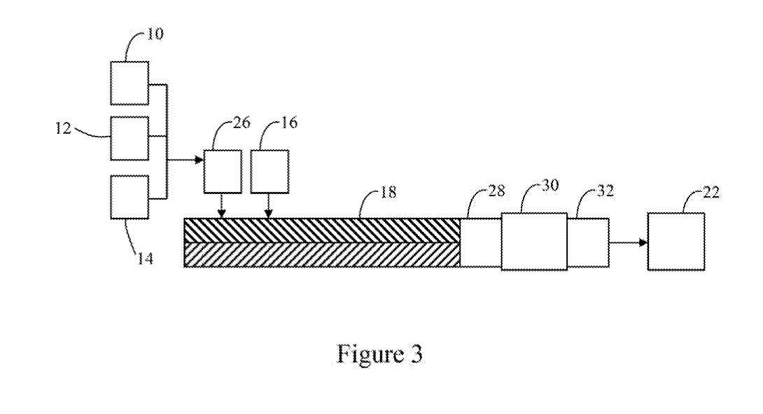

In a further exemplary process, the melt produced by the reactive extrusion can be directly extruded to form a product, such as a tube. As shown in FIG. 3, melt from the compounding extruder 18 can be directed through an extruder 30, such as by a pump 28. A tubing die 32 can direct the extruded product to the chiller 22. Direct extrusion of the melt reduces the number of thermal heat histories to which the polyisobutylene urethane copolymer is exposed before producing the final article of interest, such as a medical device.

The polyisobutylene urethane copolymer is formed by combining two immiscible components: the soft segment components comprising a polyisobutylene and the hard segment components comprising a urethane. The thermodynamic incompatibility between the segments may cause excessive phase separation during the synthesis of the polyisobutylene urethane copolymer. Inadequate mixing can lead to phase separation and result in the copolymer having a heterogeneous composition and an inconsistent morphology. For example if adequate mixing is not achieved, the resulting product may include long sequences of either the soft segment or the hard segment which can cause several problems including poor physical properties, increased opacity and difficult melt processing. The compounding extruder 18 incorporates highly dispersive and distributive mixing to control phase separation within the melt. Achieving adequate mixing as the reaction proceeds results in the segments being uniformly distributed along the polymer chain.

Polyisobutylene urethane copolymers formed by reactive extrusion may be particularly suitable for use in medical devices because of the reduced level of impurities in the copolymers. For example, polymerization by reactive extrusion can be implemented with substantially no solvent and in some examples with substantially no catalyst.

In some embodiments, a catalyst may not be required in reactive extrusion synthesis of the polyisobutylene urethane copolymer if adequate mixing of the high concentration of hard and soft segments can be achieved. In other examples, a small amount of catalyst, i.e., less than or equal to 30 ppm catalyst, may be added. The inclusion of no or a small amount of catalyst reduces the potential to form impurities in the product. Suitable catalysts include, but are not limited to, organic and inorganic salts of and organometallic derivatives of, bismuth, lead, tin, iron, antimony, uranium, cadmium, cobalt, thorium, aluminum, mercury, zinc, nickel, cerium, molybdenum, vanadium, copper, titanium, manganese and zirconium, as well as phosphines and tertiary organic amines. Preferred organotin catalysts are stannous octoate, stannous oleate, dibutyltin dioctoate, dibutyltin dilaurate and the like. Preferred tertiary organic amine catalysts include triethylamine, triethylenediamine, N,N,N′,N′-tetramethylethylenenediamine, N,N,N′,N′-tetraethylethylenediamine, N-methylmorpholine, N-ethylmorpholine, N,N,N′,N′-tetramethylguanidine, N,N,N′,N′-tetramethyl-1,3-butanediamine, N,N-dimethylethanolamine, N,N-diethylethanolamine and the like.

In contrast to solvent synthesis, a solvent may not be required for synthesis of a polyisobutylene urethane copolymer by reactive extrusion. Solvent synthesis of polyisobutylene urethane copolymers may include a solvent such as toluene, tetrahydrofuran (THF), Dimethylformamide (DMF), N-Methyl-2-pyrrolidone (NMP), and combinations thereof. Residual solvents left in a polyisobutylene urethane copolymer can pose problems during subsequent melt processing. Additionally, restrictions may be placed on the level of residual solvent and other impurities in the polyisobutylene urethane copolymer, particularly for medial grade materials. A solvent-free synthesis may also eliminate extra processing required to remove the solvent, such as a drying or devolatilizing step.

Elimination of a drying or devolatilizing step also may reduce the potential for creating hard segment crystallization. A polyisobutylene urethane copolymer can undergo excessive crystallization as estimated by the number of melting endotherms (typically labeled T1, T2, T3) seen in a differential scanning calorimetry (DSC) thermogram when subjected to heat during a drying or devolatilizing step. A consequence of these crystalline domains is that the melt temperature during subsequent melt processing steps has to be kept high (i.e., above T3) to produce a homogeneous melt. At such high temperatures there is a risk of thermal degradation or process instability due to low melt viscosity. The elimination of drying or devolatilizing steps when utilizing reactive extrusion synthesis reduces the likelihood of forming higher melting crystalline domains, and results in a low melt temperature requirement during subsequent melt processing.

The polyisobutylene urethane copolymer can be incorporated into medical devices which can be implanted or inserted into the body of a patient. Example medical devices include lead bodies, pelvic floor repair support devices, shock coil coverings, covered stents including for intestine, esophogeal and airway applications, urethral stents, internal feeding tube/balloon, embolics/bulking agents including, mitral valve repair, tumor, fibroids, structural heart applications including, PFO, valve leaflets, left atrial appendage, suture sleeves, breast implants, and ophthalmic applications, including intraocular lenses and glaucoma tubes, and spinal disc repair.

### Experimental Section

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

### Materials

Polyisobutylene diol (PIB DIOL) having a molecular weight of 2000-2100.

Terathane 1000 DRM: Polytetramethylene ether glycol (PTMEG) having a molecular weight of 1000 and available from Invista (referred to in this Experimental Section as “PTMEG”).

1,4-butanediol (BDO) available from Chemtura.

Mondur M: 4,4′-methylenediphenyl diisocyanate (MDI) available from Bayer (referred to in this Experimental Section as “MDI”).

Stannous octoate catalyst available from Octochem (referred to in this Experimental Section as “catalyst”).

### Tensile Modulus

The tensile module was determined using a modified procedure based on ASTM-D-5026.

### PIB PUR 80a Nominal Hardness: Examples 1-3

A series of reactive extrusion runs were completed using a Brabender Mini-Compounder TSE 12/36, a co-rotating twin extruder with a 12 mm diameter screw diameter and 36 D (43.2 cm) screw length available from C. W. Brabender Instruments, Inc. A single step reactive extrusion process was used in which all components were added to the twin extruder and the reaction was performed entirely within the extruder. The extruder included three ports.

For Example 1, the MDI, PIB DIOL, PTMEG, BDO and catalyst feeds were pumped into the same port at a proximal end of the extruder. Forward conveying elements RSE 18/18 were employed from the proximal end to approximately the mid-point of the extruder length. Forward conveying elements RSE 12/12 were used from the approximate mid-point to the die outlet to provide more intensive conveying of the polymer melt as the reaction proceeded and the molecular weight and viscosity increased. Example 1 used the following reaction conditions:

T1 (feed section) 149° C., 149° C., 204° C., 216° C., and 185° C. (die) (300° F., 300° F., 400° F., 420° F., and 365° F.) with a screw speed of 185 revolutions per minute (rpm) resulted in extruder pressure of 6205-6895 kPa (900-1000 psi).

Feed pump temperature and feed rates are provided in Table 1.

TABLE 1

| Pump | Temperature | Feed rate |
|---|---|---|
| Pump A, MDI | 63° C. (145° F.) | 1.68 ml/min (1.96 g/min) |
| Pump B, PIB DIOL | 71° C. (160° F.) | 3.01 ml/min (2.74 g/min) |
| Pump C, | 71° C. (160° F.) | 1.56 ml/min (1.47 g/min) |
| PTMEG/BDO/Catalyst | | |

For Example 2, the PTMEG/BDO/catalyst were fed to a first feed zone, followed by the PIB DIOL feed to a second feed zone, followed by the MDI in a third feed zone, in which the third feed zone was downstream of the second feed zone which was downstream of the first feed zone. In the feed zones, conveying elements RSE 18/18 were employed at the feed nozzles to prevent fluid backup. Each section of conveying elements RSE 18/18 was followed by a second of conveying elements RSE 12/12 to improving mixing and dispersion of the feeds. Downstream of the third feed zone, the material was conveyed into a reaction/mixing zone made up of RSE 12/12 elements followed by conveying kneading blocks RKB 45/3/12 and shearing blocks SKE 18.18. Example 2 used the following reaction conditions:

T1 (feed section) 193° C., 224° C., 224° C., 196° C., and 141° C. (die) (380° F., 435° F., 435° F., 385° F., and 285° F.) with a screw speed of 185 rpm resulted in extruder pressure of 4137-4826 kPa (600-750 psi).

Feed pump temperature, feed rates are provided in Table 2.

TABLE 2

| Pump | Temperature | Feed rate |
|---|---|---|
| Pump A, MDI | 63° C. (145° F.) | 1.41-1.50 ml/min |
| | | (1.64-1.75 g/min) |
| Pump B, PIB DIOL | 82° C. (180° F.) | 3.26 ml/min (2.97 g/min) |
| Pump C, | 71° C. (160° F.) | 1.28 ml/min (1.21 g/min) |
| PTMEG/BDO/Catalyst | | |

Note: Feed rates of MDI on Pump A were varied to adjust isocyanate index and observe strand melt strength.

Example 3 used the screw configuration described above for Example 2 and the following reaction conditions:

T1 (feed section) 193° C., 224° C., 224° C., 196° C., and 141° C. (die) (380° F., 435° F., 435° F., 385° F., and 285° F.) with a screw speed of 185 rpm resulted in extruder pressure of 5516-6205 kPa (800-900 psi).

Feed pump temperature, feed rates are provided in Table 3 for Example 3. The melt had a temperature of 192° C. (378° F.).

TABLE 3

| Pump | Temperature | Feed rate |
|---|---|---|
| Pump A, MDI | 63° C. (145° F.) | 1.46-1.50 ml/min |
| | | (1.70-1.75 g/min) |
| Pump B, PIB DIOL | 82° C. (180° F.) | 3.26 ml/min (2.97 g/min) |
| Pump C, | 71° C. (160° F.) | 1.28 ml/min (1.21 g/min) |
| PTMEG/BDO/Catalyst | | |

Feed rates of MDI on Pump A were varied to adjust Iso-index and observe strand melt strength. Examples 1 through 3 produced 80A PIB polyurethane, which typically had a tensile modulus of about 7.0 MPa and elongation at break of about 640%.

### PIB PUR 55D Nominal Hardness: Example 4

A series of reactive extrusion runs were completed using a 12 mm co-rotating extruder. The screw configuration is described herein with respect to Example 2.

Feed pump temperature, feed rates for Example 4 are provided in Table 4. The melt had a temperature of 211° C. (411° F.).

TABLE 4

| Pump | Temperature | Feed rate |
|---|---|---|
| Pump A, MDI | 63° C. (145° F.) | 1.69-1.86 ml/min |
| | | (1.97-2.17 g/min) |
| Pump B, PIB DIOL | 71° C. (160° F.) | 2.88 ml/min (2.62 g/min) |
| Pump C, | 71° C. (160° F.) | 1.28 ml/min (1.26 g/min) |
| PTMEG/BDO/Catalyst | | |

Feed rates of MDI on Pump A were varied to adjust Iso-index and observe strand melt strength. Example 4 produced a 55D PIB polyurethane which typically had a tensile modulus of about 11.8 MPa and elongation at break of about 250%. Comparing Examples 1 through 3 to Example 4, the PIB polyurethane of Example 4 had a higher tensile modulus and a smaller elongation at break.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A method of manufacturing a polyisobutylene urethane, urea or urethane/urea copolymer, the method comprising:
reacting hard segment components and soft segment components in a compounding extruder at a temperature of about 250 degrees Celsius or less in the absence of urethane, urea or urethane/urea solvents to produce the polyisobutylene urethane, urea or urethane/urea copolymer; and
extruding the polyisobutylene urethane, urea or urethane/urea copolymer,
wherein the soft segment components are present in an amount of about 40% to about 70% by weight of the biocompatible polyisobutylene urethane, urea or urethane/urea copolymer and comprise at least one polyisobutylene diol or diamine and optionally a polyether, and wherein the hard segment components are present in an amount of about 30% to about 60% by weight of the biocompatible polyisobutylene urethane and comprise diisocyanate residue.

2. The method of claim 1, wherein the soft segment components are free of a polyether diol.

3. The method of claim 1 wherein a diisocyanate:polyisobutylene diol or diamine molar ratio is between about 0.92 and about 1.10.

4. The method of claim 1, wherein the step of reacting hard segment components and soft segment components in the compounding extruder to produce the copolymer is free of a catalyst.

5. The method of claim 1, wherein the step of reacting hard segment components and soft segment components comprises adding about 30 ppm catalyst or less by weight of the hard segment components and the soft segment components.

6. The method of claim 1, and further comprising combining the hard segment components and the soft segment components to form end-capped prepolymers prior to the step of reacting the hard segment components and soft segment components to produce the copolymer.

7. The method of claim 1, wherein reacting the hard segment components and soft segment components includes adding a chain extender to the compounding extruder.

8. The method of claim 1, wherein the hard segment components and soft segment components are reacted in the compounding extruder at a temperature of about 200 degrees Celsius or less.

9. The method of claim 1, wherein extruding the polyisobutylene urethane, urea or urethane/urea copolymer includes extruding the polyisobutylene urethane, urea or urethane/urea copolymer to form an implantable medical device component.

10. The method of claim 1, wherein the hard segment components and soft segment components are reacted in the compounding extruder at a temperature of between about 140 and about 225 degrees Celsius.

11. The method of claim 1, further including:
preheating the hard segment components and the soft segment components to a temperature of between about 60 and 200 degrees Celsius before reacting hard segment components and soft segment components in the compounding extruder.

12. The method of claim 11, wherein the hard segment components and the soft segment components are preheated to a temperature of 63 to 82 degrees Celsius.

13. A method of manufacturing a polyisobutylene urethane, urea or urethane/urea copolymer, the method comprising:
preheating the hard segment components and the soft segment components to a temperature of between about 60 and 200 degrees Celsius;
reacting hard segment components and soft segment components in a compounding extruder at a temperature of between about 140 and about 225 degrees Celsius in the absence of urethane, urea or urethane/urea solvents to produce the polyisobutylene urethane, urea or urethane/urea copolymer; and
extruding the polyisobutylene urethane, urea or urethane/urea copolymer,
wherein the soft segment components are present in an amount of about 40% to about 70% by weight of the biocompatible polyisobutylene urethane, urea or urethane/urea copolymer and comprise at least one polyisobutylene diol or diamine and optionally a polyether, and wherein the hard segment components are present in an amount of about 30% to about 60% by weight of the biocompatible polyisobutylene urethane and comprise diisocyanate residue.

14. The method of claim 1 wherein a diisocyanate:polyisobutylene diol or diamine molar ratio is between about 0.92 and about 1.10.

15. The method of claim 1, wherein the step of reacting hard segment components and soft segment components in the compounding extruder to produce the copolymer is free of a catalyst.

16. The method of claim 1, wherein the hard segment components and the soft segment components are preheated to a temperature of 63 to 82 degrees Celsius.

17. A method of manufacturing a polyisobutylene urethane, urea or urethane/urea copolymer, the method comprising:
preheating the hard segment components and the soft segment components to a temperature of between about 60 and 200 degrees Celsius;
reacting hard segment components and soft segment components in a compounding extruder at a temperature of between about 140 and about 225 degrees Celsius in the absence of urethane, urea or urethane/urea solvents to produce the polyisobutylene urethane, urea or urethane/urea copolymer; and
extruding the polyisobutylene urethane, urea or urethane/urea copolymer.

18. The method of claim 17, wherein the soft segment components are free of a polyether diol.

19. The method of claim 17, and further comprising combining the hard segment components and the soft segment components to form end-capped prepolymers prior to the step of reacting the hard segment components and soft segment components to produce the copolymer.

20. The method of claim 17, wherein reacting the hard segment components and soft segment components includes adding a chain extender to the compounding extruder.
